(19) United States
(12) Patent Application Publication
(10) Pub. No.: US 2025/0327413 A1
(43) Pub. Date: Oct. 23, 2025

(54) LUBRICATION MAINTENANCE SYSTEMS AND METHODS OF CHANGING LUBRICATION IN A TURBINE ENGINE

(71) Applicant: General Electric Company, Schenectady, NY (US)

(72) Inventors: Brandon W. Miller, West Chester, OH (US); Andrew Hudecki, Milford, OH (US); Arthur W. Sibbach, Boxford, MA (US); Mark Alan Thompson, Cincinnati, OH (US)

(73) Assignee: General Electric Company, Schenectady, NY (US)

(21) Appl. No.: 18/642,911

(22) Filed: Apr. 23, 2024

(51) Int. Cl. F01M 11/04; F01M 1/10

(52) U.S. Cl. CPC F01M 11/0458; F01M 1/10; F01M 11/0408; F01M 2001/1028; F05D 2260/98

(57) ABSTRACT

A lubrication maintenance system for a gearbox assembly of a turbine engine includes a reservoir that stores a lubricant and a lubrication pump fluidly coupled to the reservoir that circulates the lubricant through the lubrication maintenance system. A heat exchanger is fluidly coupled to the lubrication pump and the gearbox assembly of the turbine engine, and a plurality of sumps are fluidly coupled to the heat exchanger. The lubrication pump is fluidly coupled to the gearbox assembly and each of the plurality of sumps, such that the lubrication pump scavenges circulated lubricant from the gearbox assembly and each of the plurality of sumps and recycles the circulated lubricant to the reservoir.

### TECHNICAL FIELD

The present specification generally relates to turbine engines and, more specifically, to lubrication maintenance systems for gearbox assemblies of a turbine engine.

### BACKGROUND

Gas turbine engines, commonly used in aircraft propulsion, utilize a continuous supply of lubrication to various components to ensure proper function and longevity. Traditionally, lubrication systems for turbine engines rely on the periodic addition of lubrication to compensate for consumption and degradation rather than complete lubrication replacement. However, these traditional lubrication systems fail to compensate for cumulative contamination and progressive degradation of lubricant over time. In high-contact pressure environments, such as those within turbine engines, the degradation and/or contamination of lubrication can lead to increase wear and eventual system failure.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional diagram of a turbine engine, taken along a centerline axis of the turbine engine, according to one or more embodiments shown and described herein;

FIG. 2 schematically depicts a lubrication maintenance system of the turbine engine of FIG. 1, according to one or more embodiments shown and described herein;

FIG. 3 schematically depicts a plurality of lubrication changing components of the lubrication maintenance system of FIG. 2, according to one or more embodiments shown and described herein;

FIG. 4 schematically depicts a plurality of priming components of the lubrication maintenance system of FIG. 2, according to one or more embodiments shown and described herein;

FIG. 5 schematically depicts a plurality of flushing components of the lubrication maintenance system of FIG. 2 including a mechanical pump, according to one or more embodiments shown and described herein;

FIG. 6 schematically depicts a plurality of flushing components of the lubrication maintenance system of FIG. 2 including an electrical pump, according to one or more embodiments shown and described herein; and

FIG. 7 schematically depicts a flow diagram of a method of changing lubricant in the lubrication maintenance system of FIG. 2, according to one or more embodiments shown and described herein;

### DETAILED DESCRIPTION

Embodiments described herein are directed to turbine engines, lubrication maintenance systems, and methods of changing lubricant in a lubrication maintenance system. The lubrication maintenance system includes a reservoir that stores a lubricant and a lubrication pump fluidly coupled to the reservoir that circulates the lubricant through the lubrication maintenance system. A heat exchanger is fluidly coupled to the lubrication pump and a gearbox assembly of the turbine engine, and a plurality of sumps are fluidly coupled to the heat exchanger. The lubrication pump is fluidly coupled to the gearbox assembly and each of the plurality of sumps, such that the lubrication pump scavenges circulated lubricant from the gearbox assembly and each of the plurality of sumps and recycles the circulated lubricant to the reservoir.

In embodiments, the lubrication maintenance system may further include a plurality of scavenge drains positioned between the plurality of sumps and the lubrication pump. At least one of the plurality of scavenge drains is positioned between the gearbox assembly and the lubrication pump. A common scavenge drain is positioned between the lubrication pump and the reservoir. The common scavenge drain is configured to drain the circulated lubricant that has been scavenged by the lubrication pump from the lubrication maintenance system and/or a reservoir valve positioned between the reservoir and the lubrication pump. By including various drains and/or valves throughout the lubrication maintenance system configured for draining and/or refilling the lubrication maintenance system, the lubrication maintenance system may be configured to enable complete lubricant changes. In these embodiments, completing full lubricant changes may ensure that contaminated and/or degraded lubricant may be flushed from the system while clean and/or fresh lubricant is used to operate the lubrication maintenance system and various components of the turbine engine.

As described herein, conventional lubrication systems for turbine engines rely on periodic addition of lubrication in order to compensate for the consumption and/or degradation of lubricant over time. Moreover, these traditional lubrication systems are not designed to accommodate convenient and efficient replacement of lubricant. In conventional lubrication systems, the process of conducting a complete lubricant change is often cumbersome, time-consuming, and may not adequately remove contaminants from the system. Furthermore, these systems fail to account for system flushing, which may lead to extended maintenance downtown and increased operational costs.

The disclosed lubrication maintenance system aims to address these limitations by facilitating comprehensive lubricant changes, efficient system flushing, and effective system priming. Furthermore, the disclosed lubrication maintenance system may be particularly adapted to the architecture of a gearbox assembly, or other similar integral drive architectures, commonly used in the turbine engines of large commercial aircraft.

Various embodiments of turbine engines, lubrication systems, and methods of changing lubricant in a turbine engine are described in more detail herein. Whenever possible, the same reference numerals will be used throughout the drawings to refer to the same or like parts.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first,” and “second” may be used interchangeably to distinguish one component from another and are not intended to signify location or importance of the individual components.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows. However, the terms “upstream” and “downstream” as used herein may also refer to a flow of electricity.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

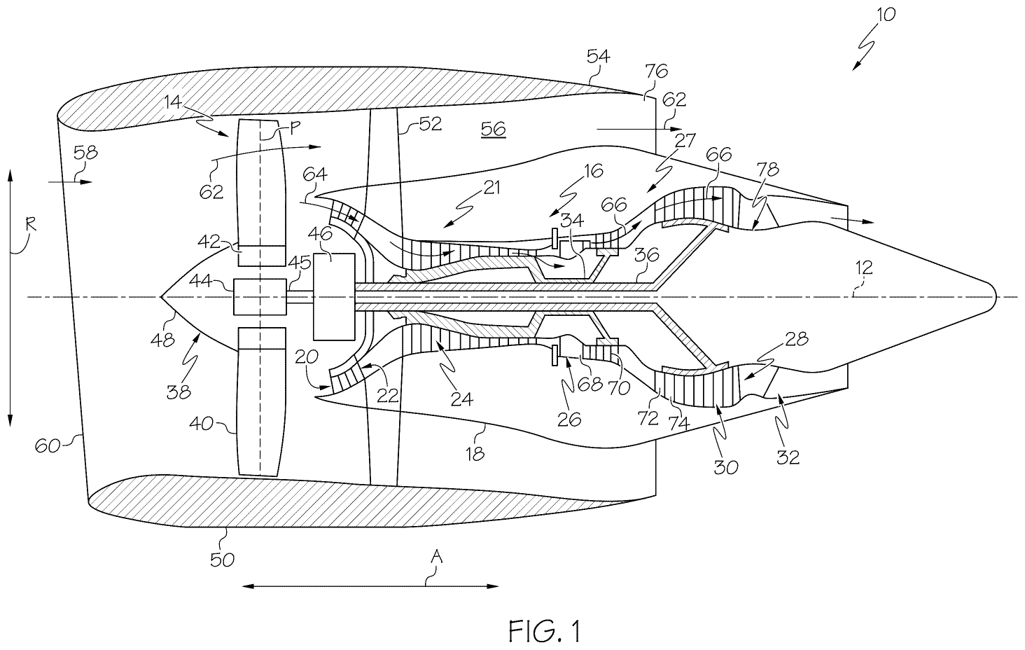

Referring now to the drawings, FIG. 1 is a schematic cross-sectional diagram of a turbine engine 10, taken along a centerline axis of the turbine engine 10, according to an embodiment of the present disclosure. As shown in FIG. 1, the turbine engine 10 defines an axial direction A (extending parallel to a longitudinal, centerline axis 12 provided for reference) and a radial direction R that is normal to the axial direction A. In general, the turbine engine 10 includes a fan section 14 and a core turbine engine 16 disposed downstream from the fan section 14.

The core turbine engine 16 depicted generally includes an outer casing 18 that is substantially tubular and defines an annular inlet 20. As schematically shown in FIG. 1, the outer casing 18 encases, in serial flow relationship, a compressor section 21 including a booster or a low pressure (LP) compressor 22 followed downstream by a high pressure (HP) compressor 24, a combustion section 26, a turbine section 27 including a high pressure (HP) turbine 28 followed downstream by a low pressure (LP) turbine 30, and a jet exhaust nozzle section 32. A high pressure (HP) shaft 34 or spool drivingly connects the HP turbine 28 to the HP compressor 24 to rotate the HP turbine 28 and the HP compressor 24 in unison. A low pressure (LP) shaft 36 drivingly connects the LP turbine 30 to the LP compressor 22 to rotate the LP turbine 30 and the LP compressor 22 in unison. The compressor section 21, the combustion section 26, the turbine section 27, and the jet exhaust nozzle section 32 together define a core air flow path.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the centerline axis 12 via a fan shaft 45 that is powered by the LP shaft 36 across a power gearbox, also referred to as a gearbox assembly 46. The gearbox assembly 46 is shown schematically in FIG. 1. The gearbox assembly 46 includes a plurality of gears for adjusting the rotational speed of the fan shaft 45 and, thus, the fan 38 relative to the LP shaft 36 to a more efficient rotational fan speed.

Referring still to the exemplary embodiment of FIG. 1, the disk 42 is covered by a rotatable fan hub 48 aerodynamically contoured to promote an airflow through the plurality of fan blades 40. In addition, the fan section 14 includes an annular fan casing or a nacelle 50 that circumferentially surrounds the fan 38 and/or at least a portion of the core turbine engine 16. The nacelle 50 is supported relative to the core turbine engine 16 by a plurality of circumferentially spaced outlet guide vanes 52. Moreover, a downstream section 54 of the nacelle 50 extends over an outer portion of the core turbine engine 16 to define a bypass airflow passage 56 therebetween.

During operation of the turbine engine 10, a volume of air 58 enters the turbine engine 10 through an inlet 60 of the nacelle 50 and/or the fan section 14. As the volume of air 58 passes across the fan blades 40, a first portion of air 62 is directed or routed into the bypass airflow passage 56, and a second portion of air 64 is directed or is routed into the upstream section of the core air flow path, or, more specifically, into the annular inlet 20 of the LP compressor 22. The ratio between the first portion of air 62 and the second portion of air 64 is commonly known as a bypass ratio. The pressure of the second portion of air 64 is then increased as the second portion of air 64 routed through the HP compressor 24 and into the combustion section 26, where the highly pressurized air is mixed with fuel and burned to provide combustion gases 66.

The combustion gases 66 are routed into the HP turbine 28 and expanded through the HP turbine 28 where a portion of thermal and/or of kinetic energy from the combustion gases 66 is extracted via sequential stages of HP turbine stator vanes 68 that are coupled to the outer casing 18 and HP turbine rotor blades 70 that are coupled to the HP shaft 34, thus, causing the HP shaft 34 to rotate, thereby supporting operation of the HP compressor 24. The combustion gases 66 are then routed into the LP turbine 30 and expanded through the LP turbine 30. Here, a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus, causing the LP shaft 36 to rotate, thereby supporting operation of the LP compressor 22 and rotation of the fan 38 via the gearbox assembly 46.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before being exhausted from a fan nozzle exhaust section 76 of the turbine engine 10, also providing propulsive thrust. The HP turbine 28, the LP turbine 30, and the jet exhaust nozzle section 32 at least partially define a hot gas path 78 for routing the combustion gases 66 through the core turbine engine 16.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable gas turbine engine, such as, for example, turbofan engines, propfan engines, turbojet engines, and/or turboshaft engines.

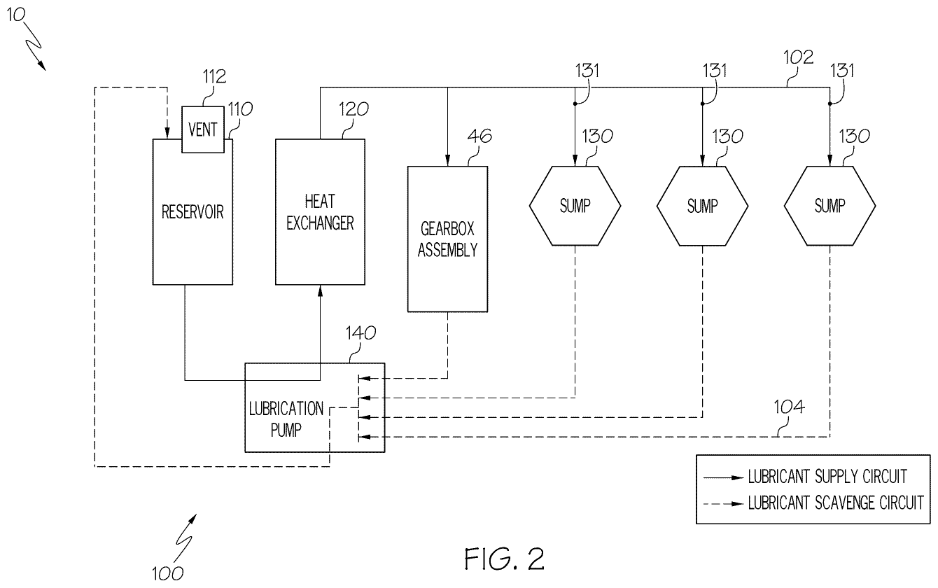

Referring now to FIG. 2, a lubrication maintenance system 100 for the turbine engine 10 is depicted. In these embodiments, the lubrication maintenance system 100 may be configured to supply lubricant to the gearbox assembly 46, as will be described in additional detail herein. As depicted in FIG. 2, the lubrication maintenance system 100 include a reservoir 110, such as a lubricant reservoir configured to store lubricant of the lubrication maintenance system 100, a heat exchanger 120, a plurality of sumps 130, and a lubrication pump 140. In these embodiments described herein, the various components of the lubrication maintenance system 100 may be fluidly coupled to form a lubricant supply circuit 102 for providing fresh, cooled, and/or filtered lubricant to the gearbox assembly 46. Additionally, a lubricant scavenge circuit 104 may be configured to collect lubricant that has traversed various components of the turbine engine 10 and/or lubrication maintenance system 100 (e.g., gearbox assembly 46, the plurality of sumps 130, etc.) and return the lubricant to the reservoir 110.

Referring still to FIG. 2, the lubrication pump 140 may be fluidly coupled to various components within the lubrication maintenance system 100 and may be configured to provide continuous and adequate lubricant flow to the various components of the turbine engine 10 that require lubrication during operation. For example, as depicted in FIG. 2, the lubrication pump 140 may be fluidly coupled to the reservoir 110, the heat exchanger 120, the gearbox assembly 46, and the plurality of sumps 130. Accordingly, in the embodiment depicted in FIG. 2, the lubrication pump 140 may circulate lubricant through (e.g., supplying lubricant to and/or scavenging lubricant from) each of the components of the lubrication maintenance system 100.

In the embodiments described herein, the lubrication pump 140 may further aid in regulating a lubricant pressure and a lubricant temperature of the lubricant as the lubricant is circulated through the lubrication maintenance system 100. For example, the lubrication pump 140 may ensure that a desired lubricant pressure is maintained within the lubrication maintenance system 100, such that lubricant is capable of reaching each component of the turbine engine 10, including those components located in positions that may not be conducive to passive lubricant flow. Similarly, the circulation of lubricant through the lubrication maintenance system 100 may further aid in dissipating heat from the various components of the turbine engine 10 and/or gearbox assembly 46. In these embodiments, the lubrication pump 140 may ensure that flow of lubricant through the lubrication maintenance system 100 is sufficient to remove excess heat from the components of the turbine engine 10 and/or gearbox assembly 46, thereby contributing to thermal management of the turbine engine 10.

Referring still to FIG. 2, it should be appreciated that the lubrication pump 140 may further act to transport contaminants away from the various components of the lubrication maintenance system 100, gearbox assembly 46, and/or turbine engine 10 as part of the lubricant scavenge circuit 104. In these embodiments, the lubrication pump 140 may circulate scavenged lubricant containing contaminants to a filter, which may act to remove the contaminants from the lubricant prior to the lubricant being recirculated through the lubrication maintenance system 100 (e.g., via the lubricant supply circuit 102). Furthermore, in the embodiments described herein, the lubrication pump 140 may be used to prime, flush, and/or drain the lubrication maintenance system 100, as will be described in additional detail herein.

In operation, circulation of lubricant through the lubrication maintenance system 100 may begin with the lubrication pump 140 drawing lubricant from the reservoir 110 and transferring the lubricant to the heat exchanger 120. As described herein, in the embodiment depicted in FIG. 2, the reservoir 110 may be configured to store lubricant for circulating through the lubrication maintenance system 100. In some embodiments, the reservoir 110 may further include a vent 112, which may serve various functions in maintaining efficient operation of the lubrication maintenance system 100.

For example, in embodiments, the vent 112 may be configured to equalize a reservoir pressure (e.g., atmospheric pressure) within the reservoir 110 as the lubricant level (e.g., volume of lubricant) within the reservoir 110 changes due to consumption, expansion, or contraction of the lubricant. In these embodiments, the vent 112 may compensate for changes in temperature and/or altitude that may result in pressure variances within the reservoir 110. Furthermore, during the lubricant filling and draining process, air may become trapped within the reservoir 110. In the embodiments described herein, the vent 112 may permit air to escape from the reservoir 110, which may prevent the formation of air pockets within the reservoir 110, which may subsequently impede operation of the lubrication pump 140.

Referring still to FIG. 2, the vent 112 of the reservoir 110 may, in some embodiments, include a filter mechanism configured to remove contaminants from lubricant that is recycled to the reservoir 110 from the lubricant scavenge circuit 104. Additionally, in the embodiments described herein, the vent 112 may allow a technician and/or user of the lubrication maintenance system 100 to easily gauge the lubricant level within the reservoir 110 without opening the reservoir 110, which may provide time-savings to maintenance operations of the reservoir 110.

Referring still to FIG. 2, the lubrication pump 140 may draw lubricant from the reservoir 110 and supply the lubricant to the heat exchanger 120. In these embodiments, the heat exchanger 120 may act to regulate the lubricant temperature of the lubricant that passes through the heat exchanger 120. For example, in the embodiments described herein, as the lubricant circulates through the lubrication maintenance system 100, the lubricant may absorb heat from the various components of the gearbox assembly 46 and/or turbine engine 10, such that the lubricant temperature of the lubricant increases. In these embodiments, the heat exchanger 120 may act to cool the lubricant prior to circulating the lubricant through the various engine components depicted in FIG. 2. It should be appreciated that, by cooling the lubricant to a desired lubricant temperature, the heat exchanger 120 may ensure that the lubricant maintains a desired lubricant viscosity, which may enable the lubricant to form an effective lubrication film between various components of the turbine engine 10 and/or gearbox assembly 46.

As further depicted in FIG. 2, lubricant may pass from the heat exchanger 120 to the plurality of sumps 130 and the gearbox assembly 46. In these embodiments, lubricant flowing through the gearbox assembly 46 may aid in lubricating the various gears and/or bearings of the gearbox assembly 46 prior to being scavenged by the lubrication pump 140 and recirculated to the reservoir 110.

Furthermore at least a portion of the lubricant may pass from the heat exchanger 120 to the plurality of sumps 130, as illustrated in FIG. 2. In these embodiments, a plurality of bearings 131 may be positioned between the heat exchanger 120 and each of the plurality of sumps 130, such that lubricant passes through the plurality of bearings 131 before entering each of the plurality of sumps 130.

As further depicted in FIG. 2, the plurality of sumps 130 may be configured as tanks positioned at low points in the turbine engine 10 where lubricant may naturally flow due to gravity. In these embodiments, the plurality of sumps 130 may collect contaminants and heat from the lubricant that circulates through the lubrication maintenance system 100. For example, as the lubricant rests within each of the plurality of sumps 130, heavier particles and/or contaminants within the lubricant may settle to a bottom portion of each of the plurality of sumps 130 due to gravity. In these embodiments, the passive filtration afforded by the plurality of sumps 130 may reduce a volume of solid contaminants that re-enter the lubrication maintenance system 100 (e.g., scavenged by the lubrication pump 140).

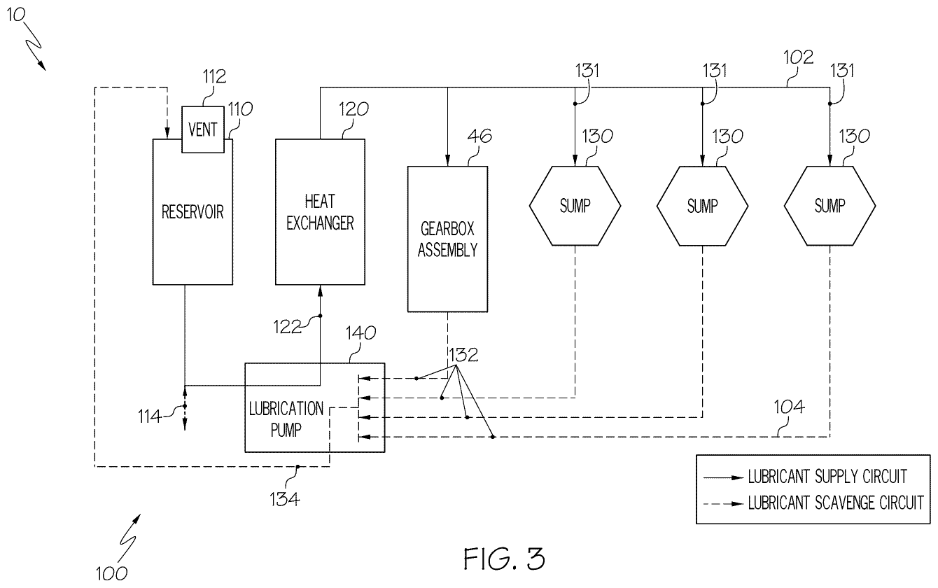

Referring still to FIG. 2, it should be further appreciated that the plurality of sumps 130 may aid in ensuring that a continuous and/or steady flow of lubricant circulates through the lubrication maintenance system 100. For example, the plurality of sumps 130 may ensure that lubricant is available to the lubrication pump 140 (e.g., to be recirculated through the lubrication maintenance system 100) regardless of an altitude and/or operational state of the turbine engine 10, which may cause the lubricant to pool in certain areas of the turbine engine 10 due to gravity. In these embodiments, the plurality of sumps 130 may also act as the points from which used lubricant may be flushed and/or drained from the lubrication maintenance system, as will be described in additional detail herein with reference to FIG. 3.

Although the plurality of sumps 130 depicted in FIG. 2 are shown as including three sumps, it should be understood that, in the embodiments described herein, the lubrication maintenance system 100 may include any number of sumps without departing from the scope of the present disclosure. For example, in embodiments, the plurality of sumps 130 may include a single sump, two sumps, four sumps, or any other number of sumps as may be necessitated by the lubricant circulation and/or storage requirements of the lubrication maintenance system 100.

Turning now to FIG. 3, the lubrication maintenance system 100 is depicted with additional components configured to aid in conducting a complete lubricant replacement process (e.g., lubricant change). As depicted in FIG. 3, the lubrication maintenance system 100 may further include a leak back valve 122 disposed between and fluidly coupled to the heat exchanger 120 and the lubrication pump 140. In these embodiments, the leak back valve 122 may ensure that lubricant that has passed through the lubrication pump 140 does not reverse flow into the reservoir 110 and/or the lubrication pump 140. Furthermore, in the embodiments described herein, the leak back valve 122 may further act to ensure that, once lubricant is drained from the lubrication maintenance system 100, contaminated lubricant may not re-enter cleaned and/or drained components of the lubrication maintenance system 100.

As further depicted in FIG. 3, the lubrication maintenance system 100 may further include a plurality of scavenge drains 132, which may be positioned between the gearbox assembly 46 and the lubrication pump 140 and/or between the plurality of sumps 130 and the lubrication pump 140. In these embodiments, the plurality of scavenge drains 132 may allow for lubricant that flows through each of the plurality of sumps 130 and the gearbox assembly 46 to be individually scavenged and/or drained from the lubrication maintenance system 100, which may be desirable for thorough maintenance of the lubrication maintenance system 100 and/or specific service procedures.

In some embodiments, the lubrication maintenance system 100 may further include a common scavenge drain 134. As illustrated in FIG. 3, the common scavenge drain 134 may be positioned between the lubrication pump 140 and the reservoir 110 as a portion of the lubricant scavenge circuit 104. In these embodiments, scavenged lubricant from each of the plurality of sumps 130 and the gearbox assembly 46 that is circulated to the lubrication pump 140 may be drained from the lubrication maintenance system 100 simultaneously via the common scavenge drain 134, such that the common scavenge drain 134 acts as a centralized draining point for the lubrication maintenance system 100. It should be appreciated that, in these embodiments, draining lubricant from the common scavenge drain 134 may simplify the lubricant changing process, as will be described in additional detail herein.

Although FIG. 3 depicts the lubrication maintenance system 100 as including a plurality of scavenge drains 132 and a common scavenge drain 134, it should be appreciated that, in some embodiments, the lubrication maintenance system 100 may include either of the plurality of scavenge drains 132 or the common scavenge drain 134 without departing from the scope of the present disclosure. Furthermore, it should be understood that the plurality of scavenge drains 132 may include any number of scavenge drains 134. For example, in some embodiments, such as the embodiment depicted in FIG. 3, at least one of the plurality of scavenge drains 132 may be positioned between each of the plurality of sumps 130 and the lubrication pump 140 and between the gearbox 46 and the lubrication pump 140. However, in other embodiments, the number of the plurality of scavenge drains 132 may be different from the number of the plurality of sumps 130.

Referring still to FIG. 3, it should be further appreciated that positioning of each of the plurality of scavenge drains 132 and/or the common scavenge drain 134 may be determined based on a residual lubricant volume present in the lubrication maintenance system 100 and/or other similar design considerations. Accordingly, it should be appreciated that the plurality of scavenge drains 132 may be positioned at any location between the gearbox assembly 46 and the lubrication pump 140 and/or between the plurality of sumps 130 and the lubrication pump 140 along a length of the lubricant scavenge circuit 104. Similarly, the common scavenge drain 134 may be positioned at any location between the lubrication pump 140 and the reservoir 110 without departing from the scope of the present disclosure.

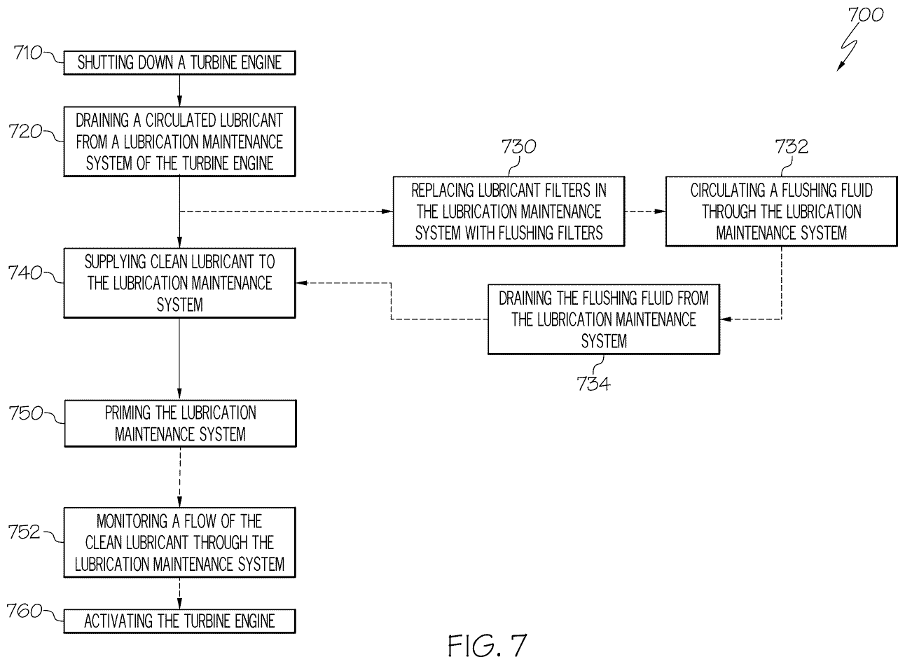

As further depicted in FIG. 3, in these embodiments, the lubrication maintenance system 100 may further include a reservoir valve 114 positioned between the reservoir 110 and the lubrication pump 140. In the embodiments described herein, the reservoir valve 114 may be configured to allow for lubricant to be drained from the reservoir 110 during lubricant changing process and to allow for lubricant to be provided to the reservoir 110 during priming procedures, as will be described in additional detail herein. It should be appreciated that the positioning of the reservoir valve 114, the plurality of scavenge drains 132, and/or the common scavenge drain 134 may allow for complete lubricant removal from and refilling of the lubrication maintenance system 100, as will be described herein with reference to FIG. 7.

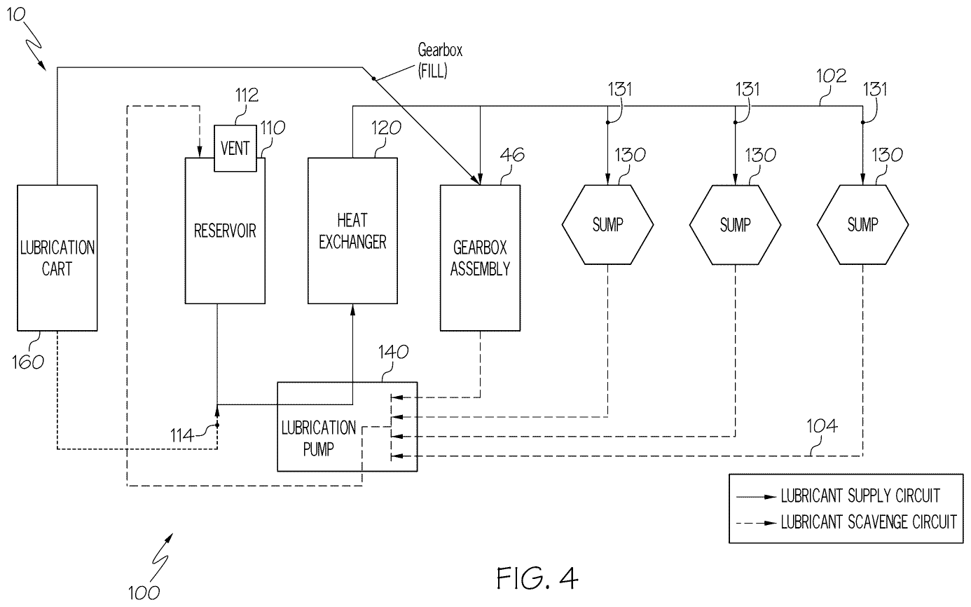

Turning now to FIG. 4, the lubrication maintenance system 100 is depicted with additional components for performing a priming process. In these embodiments, the priming process may refer to the process of ensuring that the lubrication maintenance system 100 is fully filled with lubricant and free from air pockets before starting up the turbine engine 10. In these embodiments, it should be appreciated that the priming process may be conducted following a lubricant change process (e.g., after a complete lubricant change in which lubricant has been drained from the lubrication maintenance system 100 and the lubrication maintenance system 100 has been refilled with clean lubricant) and before restarting the turbine engine 10.

As depicted in FIG. 4, in these embodiments, the lubrication maintenance system 100 may further include a lubricant cart 160, which may be configured to be fluidly couplable to a lubricant line extending between the lubrication pump 140 and the reservoir 110. For example, the lubrication maintenance system 100 may include a lubrication cart port positioned between the lubrication pump 140 and the reservoir 110 that may be used to fluidly couple the lubricant cart 160 to the lubrication maintenance system 100. In other embodiments, the lubricant cart 160 may be configured to be fluidly coupled to the vent 112 of the reservoir 110. Accordingly, in the embodiments described herein, the lubricant cart 160 may be used to supply new (e.g., clean) lubricant to the lubrication maintenance system 100 via the reservoir 110. In the embodiments described herein, it should be appreciated that the lubricant cart 160 may be an engine based cart or a ground-based cart, as may be necessitated by the configuration of the lubrication maintenance system 100.

As further depicted in FIG. 4, in some embodiments, the lubricant cart 160 may be directly fluidly coupled to the gearbox assembly 46 in addition to and/or instead of the reservoir 110. In these embodiments, the lubricant cart 160 may allow for the direct addition of lubricant to the gearbox assembly 46 in order to ensure efficient operation of the gearbox 46 while minimizing wear on any gears and/or bearings positioned within the gearbox assembly 46. Furthermore, it should be understood that directly filling the gearbox assembly 46 with lubricant (e.g., via the lubricant cart 160) may further aid in cooling the various components of the gearbox assembly 46.

In the embodiments described herein, the direct fluid coupling of the lubricant cart 160 and the gearbox assembly 46 may further aid in facilitating the priming process of the lubrication maintenance system 100. For example, during maintenance, air may become trapped within various components of the turbine engine 10, including the gearbox assembly 46. By directly coupling the lubricant cart 160 to the gearbox assembly 46, it may be possible to ensure that lubricant reaches each of the various components of the gearbox assembly 46, thereby removing any trapped air and preventing cavitation.

Furthermore, it should be appreciated that various operational environments and/or turbine engines 10 may utilize customized lubrication strategies. Accordingly, the direct fluid coupling of the lubricant cart 160 and the gearbox assembly 46 may provide flexibility in managing a type and/or volume of lubricant provided to the gearbox assembly 46 during a priming process, as will be described in additional detail herein with reference to FIG. 7. Furthermore, it should be understood that the remaining components of the lubrication maintenance system 100 depicted in FIG. 4 have been previously described herein with reference to FIGS. 2 and 3.

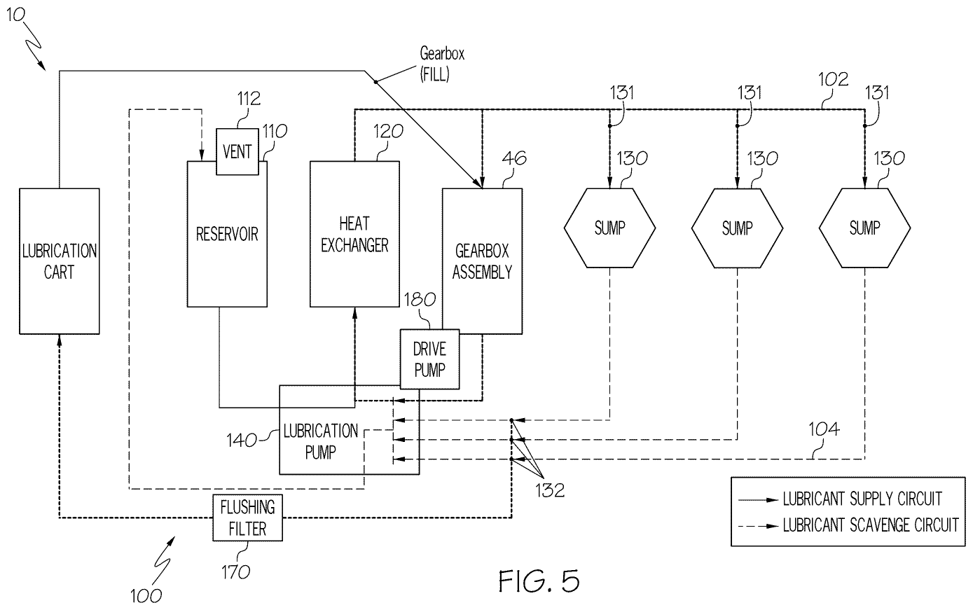

Turning now to FIG. 5, the lubrication maintenance system 100 is depicted with additional components for performing a flushing process. In these embodiments, the flushing process may be used to remove contaminants, debris, and/or degraded lubricant from the lubrication maintenance system 100 in an effort to extend the life of the turbine engine 10 and ensure efficient operation of the lubrication maintenance system 100.

As depicted in FIG. 5, in these embodiments, the lubrication maintenance system 100 may further include a flushing filter 170, which may be positioned between the plurality of scavenge drains 132 and the lubricant cart 160. The flushing filter 170 may be configured to dislodge and/or suspend various contaminants from a flushing fluid that is circulated through the lubrication maintenance system 100 during the flushing process. By utilizing the flushing filter 170, it may be possible to protect any other lubricant filters within the lubrication maintenance system 100, thereby ensuring that these lubricant filters are not loaded with contaminants during the flushing process. Details of the flushing process using the lubrication maintenance system 100 depicted in FIG. 5 will be described in additional detail herein with reference to FIG. 7.

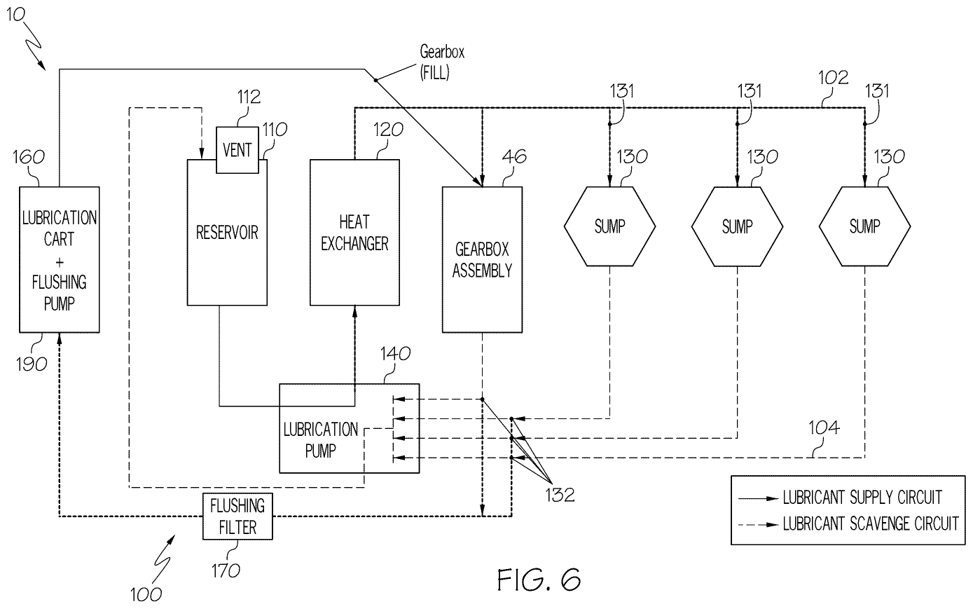

Referring now to FIGS. 5 and 6, it should be appreciated that, in order to effectively complete the flushing process of the lubrication maintenance system 100, the flushing fluid utilized to complete the flushing process may be circulated through the lubrication maintenance system 100. In these embodiments, circulation of the flushing fluid through the lubrication maintenance system 100 may be conducted using either a mechanically driven pump, such as a drive pump 180 (FIG. 5), or an electrically driven pump, such as a flushing pump 190 (FIG. 6) formed as part of the lubricant cart 160.

In the embodiments depicted in FIGS. 5 and 6, the lubrication pump 140 may be powered by the turbine engine 10 during operation. However, the turbine engine 10 may be shut off during the flushing process, as will be described in additional detail herein. Accordingly, the lubrication maintenance system 100 may utilize external power sources and/or components to power the lubrication pump 140 and/or circulate flushing fluid through the lubrication maintenance system 100 during the flushing process.

For example, as illustrated in FIG. 5, the drive pump 180 may be utilized as an external power source to power the lubrication pump 140 during the flushing process. In these embodiments, the drive pump 180 may power the lubrication pump 140, which may in turn be used to circulate flushing fluid through the lubrication maintenance system 100. In other embodiments, such as those depicted in FIG. 6, the lubricant cart 160 may further include a flushing pump 190, which may be used to circulate the flushing fluid through the lubrication maintenance system 100 during the flushing process.

Referring now to FIG. 7, and with reference to FIGS. 2-6, a method 700 of changing lubricant in the lubrication maintenance system 100 will now be described in additional detail. As should be appreciated in view of the foregoing, the method 700 of changing the lubricant in the lubrication maintenance system 100 may further include priming the lubrication maintenance system 100 and/or flushing the lubrication maintenance system 100, as will be described in additional detail herein.

As depicted in FIG. 7, the method 700 may initially include shutting down the turbine engine 10, as depicted at block 710. In these embodiments, the turbine engine 10 may be shut down prior to performing the lubricant change to ensure that the turbine engine 10 is cooled to a safe temperature and/or to prevent any injuries and/or damage that may occur during the lubricant change process.

With the turbine engine 10 shut off and cooled, the method 700 may advance to block 720, which may involve draining a circulated lubricant from the lubrication maintenance system 100. In these embodiments, the method step of block 720 may further involve draining the circulated lubricant from various components of the lubrication maintenance system 100. For example, the method step of draining the circulated lubricant from the lubrication maintenance system 100 may involve opening the vent 112 of the reservoir 110, the reservoir valve 114, the plurality of scavenge drains 132, and/or the common scavenge drain 134 and draining circulated lubricant from any and/or each of the components such that the circulated lubricant is fully removed from the lubrication maintenance system 100.

Once the circulated lubricant is drained (e.g., removed) from the lubrication maintenance system 100, in some embodiments, the method 700 may further involve flushing the lubrication maintenance system 100. In embodiments in which the flushing process is conducted, the method may advance to block 730, which may involve replacing lubricant filters with flushing filters (e.g., temporary flushing filters) configured to capture contaminants dislodged from the lubrication maintenance system 100 during the flushing process.

With the flushing filters in place, the method 700 may advance to block 732, which may include circulating a flushing fluid through the lubrication maintenance system 100. In these embodiments, flushing fluid may be provided to the lubrication maintenance system 100 via the lubricant cart 160, which may be fluidly coupled to the vent 112 of the reservoir 110 and/or to a lubrication supply port positioned between the reservoir 110 and the lubrication pump 140. Once the flushing fluid has been provided to the lubrication maintenance system 100, an external power source, such as a drive pump 180 (FIG. 5) or a flushing pump 190 (FIG. 6) may be activated to circulate the flushing fluid through the lubrication maintenance system 100. It should be appreciated that, in embodiments in which the method 700 includes the flushing process, any of the vent 112 of the reservoir 110, the reservoir valve 114, the plurality of scavenge drains 132, and/or the common scavenge drain 134 that may be opened during the draining step of block 720, may be closed prior to circulating the flushing fluid through the lubrication maintenance system 100.

Referring still to FIG. 7, once the flushing fluid has been circulated through the lubrication maintenance system 100, the method 700 may advance to block 734, which may involve draining the flushing fluid from the lubrication maintenance system 100. In these embodiments, the method step of draining the flushing fluid from the lubrication maintenance system 100 at block 734 may be similar to the method step of draining the circulated lubricant from the lubrication maintenance system 100 depicted at block 720. With the flushing fluid drained from the lubrication maintenance system 100, the lubricant filters may be reinstalled to complete the flushing process.

Once the flushing fluid has been drained from the lubrication maintenance system 100, the method 700 may advance to block 740, which may involve supplying clean lubricant to the lubrication maintenance system 100. In these embodiments, clean lubricant may be provided to the lubrication maintenance system 100 by supplying clean lubricant to the reservoir 110 from the lubricant cart 160. It should be appreciated that, in the embodiments described herein, any of the vent 112 of the reservoir 110, the reservoir valve 114, the plurality of scavenge drains 132, and/or the common scavenge drain 134 that may be opened during the draining step of block 734 may be closed prior to refilling the lubrication maintenance system 100 with clean lubricant.

In some embodiments, once the lubrication maintenance system 100 has been refilled with clean lubricant, the method may further involve priming the lubrication maintenance system 100 prior to starting up the turbine engine 10. In these embodiments, the method 700 may further involve priming the lubrication maintenance system 100 by circulating the clean lubricant through the various components of the lubrication maintenance system 100, as depicted at block 750. As the clean lubricant is circulated through the lubrication maintenance system 100, the method 700 may further involve monitoring a flow of clean lubricant through the lubrication maintenance system 100 to confirm that air has been removed from the lubrication maintenance system 100, as shown at block 752.

Referring still to FIG. 7, once the priming process is complete and air has been removed from the lubrication maintenance system 100, the method 700 may advance to block 760, which may involve starting up the turbine engine 10. In these embodiments, the turbine engine 10 may power the lubrication pump 140 of the lubrication maintenance system 100 to ensure that lubricant is continuously circulated throughout the lubrication maintenance system 100 and gearbox assembly 46 during operation of the turbine engine 10.

In view of the foregoing, it is to be appreciated that defined herein are turbine engines, lubrication maintenance systems, and methods of changing lubricant in a lubrication maintenance system. The lubrication maintenance system for a turbine engine includes a reservoir that stores a lubricant and a lubrication pump fluidly coupled to the reservoir that circulates the lubricant through the lubrication maintenance system. A heat exchanger is fluidly coupled to the lubrication pump and the gearbox of the turbine engine, and a plurality of sumps are fluidly coupled to the heat exchanger. The lubrication pump is fluidly coupled to the gearbox and each of the plurality of sumps, such that the lubrication pump scavenges circulated lubricant from the gearbox and each of the plurality of sumps and recycles the circulated lubricant to the reservoir. In embodiments, the lubrication maintenance system may further include a plurality of scavenge drains positioned between the plurality of sumps and the lubrication pump, at least one of the plurality of scavenge drains positioned between the gearbox assembly and the lubrication pump, a common scavenge drain positioned between the lubrication pump and the reservoir, the common scavenge drain being configured to drain the circulated lubricant that has been scavenged by the lubrication pump from the lubrication maintenance system and/or a reservoir valve positioned between the reservoir and the lubrication pump. By including various drains and/or valves throughout the lubrication maintenance system configured for draining and/or refilling the lubrication maintenance system, the lubrication maintenance system may be configured to enable complete lubricant changes. In these embodiments, completing full lubricant changes may ensure that contaminated and/or degraded lubricant may be flushed from the system while clean and/or fresh lubricant is used to operate the lubrication maintenance system and various components of the turbine engine.

Further aspects of the embodiments described herein are provided by the subject matter of the following clauses:

A lubrication maintenance system for a gearbox assembly of a turbine engine comprising: a reservoir configured to store a lubricant; a lubrication pump fluidly coupled to the reservoir, the lubrication pump configured to circulate the lubricant through the lubrication maintenance system; a heat exchanger fluidly coupled to the lubrication pump and the gearbox assembly of the turbine engine; and a plurality of sumps fluidly coupled to the heat exchanger; wherein the lubrication pump is further fluidly coupled to the gearbox assembly and each of the plurality of sumps, such that the lubrication pump is configured to scavenge circulated lubricant from the gearbox assembly and each of the plurality of sumps and recycle the circulated lubricant to the reservoir

The lubrication maintenance system according to any preceding clause, wherein the reservoir further includes a vent configured to equalize a reservoir pressure within the reservoir as the lubrication pump circulates the lubricant through the lubrication maintenance system.

The lubrication maintenance system according to any preceding clause, wherein the vent of the reservoir further includes a lubricant filter configured to remove contaminants from the circulated lubricant recycled to the reservoir.

The lubrication maintenance system according to any preceding clause, further including a leak back valve disposed between and fluidly coupled to the heat exchanger and the lubrication pump, the leak back valve being configured to prevent reverse flow of the lubricant.

The lubrication maintenance system according to any preceding clause, further including a plurality of scavenge drains positioned between the plurality of sumps and the lubrication pump, the plurality of scavenge drains being configured to drain the circulated lubricant from each of the plurality of sumps.

The lubrication maintenance system according to any preceding clause, wherein at least one of the plurality of scavenge drains is positioned between the gearbox and the lubrication pump, the at least one of the plurality of scavenge drains being configured to drain the circulated lubricant from the gearbox.

The lubrication maintenance system according to any preceding clause, further including a common scavenge drain positioned between the lubrication pump and the reservoir, the common scavenge drain being configured to drain the circulated lubricant that has been scavenged by the lubrication pump from the lubrication maintenance system.

The lubrication maintenance system according to any preceding clause, wherein the reservoir further includes a reservoir valve positioned between the reservoir and the lubrication pump, the reservoir valve being configured to drain the lubricant from the reservoir.

The lubrication maintenance system according to any preceding clause, further including a lubrication cart that is fluidly couplable to the reservoir, such that the lubrication cart is configured to supply a clean lubricant to the reservoir.

The lubrication maintenance system according to any preceding clause, wherein the lubrication cart is fluidly couplable to the gearbox of the turbine engine, such that the lubrication cart is configured to supply the clean lubricant directly to the gearbox.

The lubrication maintenance system according to any preceding clause, wherein the lubrication cart is further configured to provide a flushing fluid to the reservoir.

The lubrication maintenance system according to any preceding clause, wherein the lubrication cart further comprises a flushing pump configured to circulate the flushing fluid through the lubrication maintenance system when the turbine engine is shut down.

The lubrication maintenance system according to any preceding clause, further including a drive pump configured to circulate the flushing fluid through the lubrication maintenance system when the turbine engine is shut down.

A turbine engine comprising: a fan section including a fan; a fan shaft coupled to the fan, the fan shaft configured to rotate the fan; a turbine section including a high pressure shaft and a low pressure shaft; a gearbox assembly mechanically coupled to the turbine section; and a lubrication maintenance system comprising: a reservoir configured to store a lubricant; a lubrication pump fluidly coupled to the reservoir, the lubrication pump being configured to circulate the lubricant through the lubrication maintenance system; a heat exchanger fluidly coupled to the lubrication pump and the gearbox assembly of the turbine engine; and a plurality of sumps fluidly coupled to the heat exchanger; wherein the lubrication pump is further fluidly coupled to the gearbox assembly and each of the plurality of sumps, such that the lubrication pump is configured to scavenge circulated lubricant from the gearbox assembly and each of the plurality of sumps and recycle the circulated lubricant to the reservoir.

The turbine engine according to any preceding clause, further including a plurality of scavenge drains positioned between the plurality of sumps and the lubrication pump, the plurality of scavenge drains being configured to drain the circulated lubricant from each of the plurality of sumps.

The turbine engine according to any preceding clause, wherein at least one of the plurality of scavenge drains is positioned between the gearbox and the lubrication pump, the at least one of the plurality of scavenge drains being configured to drain the circulated lubricant from the gearbox.

The turbine engine according to any preceding clause, further including a common scavenge drain positioned between the lubrication pump and the reservoir, the common scavenge drain being configured to drain the circulated lubricant that has been scavenged by the lubrication pump from the lubrication maintenance system.

The turbine engine according to any preceding clause, wherein the reservoir further includes a reservoir valve positioned between the reservoir and the lubrication pump, the reservoir valve being configured to drain the lubricant from the reservoir.

A method of changing a lubricant in a lubrication maintenance system of a turbine engine, the method including: shutting down the turbine engine; draining a circulated lubricant from the lubrication maintenance system; replacing a lubricant filter in a reservoir of the lubrication maintenance system with a flushing filter; circulating a flushing fluid through the lubrication maintenance system; draining the flushing fluid from the lubrication maintenance system, and supplying a clean lubricant to the lubrication maintenance system.

The method according to any preceding clause, wherein draining the circulated lubricant from the lubrication maintenance system further involves opening a reservoir valve of the reservoir configured to drain circulated lubricant from the reservoir.

The method according to any preceding clause, wherein circulating the flushing fluid further includes using a lubrication pump to move the flushing fluid through the lubrication maintenance system.

The method according to any preceding clause, wherein draining the flushing fluid includes using a plurality of scavenge drains positioned between the gearbox assembly and the lubrication pump to drain the flushing fluid.

The method according to any preceding clause, further including priming the lubrication maintenance system by circulating the clean lubricant through the lubrication maintenance system.

The method according to any preceding clause, further including the steps of: monitoring a flow of the clean lubricant through the lubrication maintenance system to confirm that air has been removed from the lubrication maintenance system; and starting up the turbine engine.

The method according to any preceding clause, wherein supplying the clean lubricant to the lubrication maintenance system includes using a lubricant cart configured to supply clean lubricant directly to the reservoir.

The method according to any preceding clause, wherein the lubricant cart is further configured to supply the clean lubricant directly to the gearbox assembly.

The method according to any preceding clause, further comprising conducting a system leak test after supplying the clean lubricant to the lubrication maintenance system.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A lubrication maintenance system for a gearbox assembly of a turbine engine comprising:
a reservoir configured to store a lubricant;
a lubrication pump fluidly coupled to the reservoir, the lubrication pump configured to circulate the lubricant through the lubrication maintenance system;
a heat exchanger fluidly coupled to the lubrication pump and the gearbox assembly of the turbine engine; and
a plurality of sumps fluidly coupled to the heat exchanger;
wherein the lubrication pump is further fluidly coupled to the gearbox assembly and each of the plurality of sumps, such that the lubrication pump is configured to scavenge circulated lubricant from the gearbox assembly and each of the plurality of sumps and recycle the circulated lubricant to the reservoir.

2. The lubrication maintenance system of claim 1, wherein the reservoir further includes a vent configured to equalize a reservoir pressure within the reservoir as the lubrication pump circulates the lubricant through the lubrication maintenance system.

3. The lubrication maintenance system of claim 2, wherein the vent further includes a lubricant filter configured to remove contaminants from the circulated lubricant recycled to the reservoir.

4. The lubrication maintenance system of claim 1, further comprising a leak back valve disposed between and fluidly coupled to the heat exchanger and the lubrication pump, the leak back valve being configured to prevent reverse flow of the lubricant.

5. The lubrication maintenance system of claim 1, further comprising a plurality of scavenge drains positioned between the plurality of sumps and the lubrication pump, the plurality of scavenge drains being configured to drain the circulated lubricant from each of the plurality of sumps.

6. The lubrication maintenance system of claim 5, wherein at least one of the plurality of scavenge drains is positioned between the gearbox assembly and the lubrication pump, the at least one of the plurality of scavenge drains being configured to drain the circulated lubricant from the gearbox assembly.

7. The lubrication maintenance system of claim 1, further comprising a common scavenge drain positioned between the lubrication pump and the reservoir, the common scavenge drain configured to drain the circulated lubricant scavenged by the lubrication pump from the lubrication maintenance system.

8. The lubrication maintenance system of claim 1, wherein the reservoir further includes a reservoir valve positioned between the reservoir and the lubrication pump, the reservoir valve configured to drain the lubricant from the reservoir.

9. The lubrication maintenance system of claim 1, further comprising a lubrication cart that is fluidly couplable to the reservoir, such that the lubrication cart is configured to supply a clean lubricant to the reservoir.

10. The lubrication maintenance system of claim 9, wherein the lubrication cart is fluidly couplable to the gearbox assembly of the turbine engine, such that the lubrication cart is configured to supply the clean lubricant directly to the gearbox assembly.

11. The lubrication maintenance system of claim 9, wherein the lubrication cart is further configured to provide a flushing fluid to the reservoir.

12. The lubrication maintenance system of claim 11, wherein the lubrication cart further comprises a flushing pump configured to circulate the flushing fluid through the lubrication maintenance system when the turbine engine is shut down.

13. The lubrication maintenance system of claim 11, further comprising a drive pump configured to circulate the flushing fluid through the lubrication maintenance system when the turbine engine is shut down.

14. A turbine engine comprising:
a fan section including a fan;
a fan shaft coupled to the fan, the fan shaft configured to rotate the fan;
a turbine section including a high pressure shaft and a low pressure shaft;
a gearbox assembly mechanically coupled to the turbine section; and
a lubrication maintenance system comprising:
a reservoir configured to store a lubricant;
a lubrication pump fluidly coupled to the reservoir, the lubrication pump being configured to circulate the lubricant through the lubrication maintenance system;
a heat exchanger fluidly coupled to the lubrication pump and the gearbox assembly of the turbine engine; and
a plurality of sumps fluidly coupled to the heat exchanger;
wherein the lubrication pump is further fluidly coupled to the gearbox assembly and each of the plurality of sumps, such that the lubrication pump is configured to scavenge circulated lubricant from the gearbox assembly and each of the plurality of sumps and recycle the circulated lubricant to the reservoir.

15. The turbine engine of claim 14, further comprising a plurality of scavenge drains positioned between the plurality of sumps and the lubrication pump, the plurality of scavenge drains being configured to drain the circulated lubricant from each of the plurality of sumps.

16. The turbine engine of claim 14, further comprising a plurality of scavenge drains, where at least one of the plurality of scavenge drains is positioned between the gearbox assembly and the lubrication pump, the at least one of the plurality of scavenge drains being configured to drain the circulated lubricant from the gearbox assembly.

17. The turbine engine of claim 14, further comprising a common scavenge drain positioned between the lubrication pump and the reservoir, the common scavenge drain being configured to drain the circulated lubricant that has been scavenged by the lubrication pump from the lubrication maintenance system.

18. The turbine engine of claim 14, wherein the reservoir further includes a reservoir valve positioned between the reservoir and the lubrication pump, the reservoir valve being configured to drain the lubricant from the reservoir.

19. A method of changing a lubricant in a lubrication maintenance system of a turbine engine, the method comprising:
shutting down the turbine engine;
draining a circulated lubricant from the lubrication maintenance system;
replacing a lubricant filter in a reservoir of the lubrication maintenance system with a flushing filter;
circulating a flushing fluid through the lubrication maintenance system;
draining the flushing fluid from the lubrication maintenance system; and
supplying a clean lubricant to the lubrication maintenance system.

20. The method of claim 19, further comprising the steps of:
priming the lubrication maintenance system by circulating the clean lubricant through the lubrication maintenance system;
monitoring a flow of the clean lubricant through the lubrication maintenance system; and
starting up the turbine engine.
